(19) United States
(12) Patent Application Publication
(10) Pub. No.: US 2005/0054531 A1
(43) Pub. Date: Mar. 10, 2005

(54) N-(phosphonomethyl) glycine (glyphosate) salt, a preparation process thereof, a concentrate composition and a phytotoxic formulation comprising it, and a method to combat weeds in a crop with a formulation thereto

(76) Inventor: Norberto Chutrau, Buenos Aires (AR)

Correspondence Address: YOUNG & THOMPSON, 745 SOUTH 23RD STREET, 2ND FLOOR, ARLINGTON, VA, 22202, US

(21) Appl. No.: 10/929,571

(22) Filed: Aug. 31, 2004

(30) Foreign Application Priority Data
Sep. 4, 2003 (AR) P03 01 03203

(51) Int. Cl. A01N 57/00; A01N 57/18

(52) U.S. Cl. 504/197

(57) ABSTRACT

The N-(phosphonomethyl)glycine (Glyphosate) salt which is the N-(phosphonomethylglycine) 1H-1,2,4-triazol-3-ylamine salt (Glyphosate triazolamine salt). Preferably, it is the N-(phosphonomethylglycine) mono-1H-1,2,4-triazol-3-ylamine salt (Glyphosate mono-triazolamine salt) of formula: 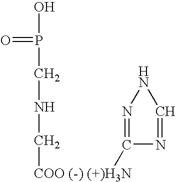
Useful concentrate composition for the “in situ” preparation of a phytotoxic formulation by dilution with water, or by dissolution in water to reach a required active compound concentration, which is a liquid or solid product wherein the active compound comprises the Glyphosate triazolamine salt, and at least an auxiliary including agriculturally acceptable diluents, extensors, carriers, conditioning agents, humidifying agents, and/or dispersing or emulsifying agents; and such phytotoxic formulation. A process to prepare a liquid concentrate composition of the Glyphosate triazolamine salt comprising: (a) suspending acid glyphosate in water; and (b) slowly adding triazolamine under constant stirring, and keeping the temperature from 15 to 40° C., and additionally adding an agriculturally acceptable auxiliary; and a process to prepare a solid concentrate composition of the Glyphosate triazolamine salt comprising the mixture of acid glyphosate and triazolamine, and the additional addition of an agriculturally acceptable auxiliary. A method to combat weeds in a crop by the application of the phytotoxic formulation on the existing weeds in a crop, or a plantation of fruit trees, to control weeds, preferably Aleppo grass (Sorghum halepense), Bermuda grass (Cynodon dactylon, water grass (Echinochloa crusgalli), summer grass (Digitaria sanguinalis), sunchillo (Wedelia glauca), nutgrass (Cyperus rotundus), blite (Amaranthus quitensis), wild buckwheat (Polygonum convolvulus), and pigweed (Chenopodium album).

### FIELD OF THE INVENTION

The present invention relates to a N-phosphonomethyl-glycine salt useful as a herbicide, or with phytotoxic features, specially to the glyphosate triazolamine salt. Additionally, this invention relates to a process to obtain such a salt, the compositions, and the phytotoxic formulations comprising the active compound thereof, and a method to combat weeds in a culture.

### BACKGROUND OF THE INVENTION

N-(phosphonomethyl)-glycines comprise a family of compounds, well known for the phytotoxic activity thereof. One of them, known under the registered commercial brand “Glyphosate” is a very active phytotoxic tricarboxilic acid, although the industrial-scale application thereof has not been successful due to the reduced solubility of the compound in aqueous medium, and also in organic solvents compatible with agricultural developments, like other compounds comprised by such a family.

This reduced adaptability and capacity of this acid known of glyphosate to form commercially desired solutions, have led to substitution of the mentioned acid by the salts thereof, generally much more soluble, as occurs with salts from group IA and IIA elements in the Periodic Table, and the amine salts thereof; specially primary organic amine salts. In practice, these salts comprise compounds obtained by salination of not more than two protonable atoms in the N-(phosphonomethyl)-glycine of Formula:

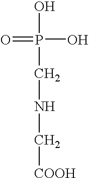

In the literature, the description of N-(phosphonomethyl)-glycines is specially associated to mentioning alkaline metal or alkaline earth salts, amine and ammonium salts, and transition metal salts.

Particularly, reference is made to obtaining and possible applications of potassium, calcium, and magnesium monosalts, and dimetilamine monosalt. Ammonium monosalts, for example, are generically mentioned in a simple list of bases sufficiently strong to saltify at least one of the three protonable hydrogen atoms of the Glyphosate molecule.

For the extremely generalized application, effectiveness, and adaptability for commercial formulation preparations thereof, among all the proposed and tested salts, Glyphosate iso-propylamine monosalt or monobasic salt stands out, known under the denomination MIPA (mono-N-iso-propylamine (phosphonomethyl-glycinate).

Post-emergency treatment of unwanted vegetation, together with established herbal vegetation, even of aquatic plants, has in the glyphosate iso-propylamine monosalt a very efficient ally due to the phytotoxic activity on unwanted weeds thereof, being generally applied in comparison with other N-phosphonomethyl-glycine salts. Commercial practice allow the availability of MIPA in 48% concentrate aqueous solution, ready to be diluted with water “in situ”, as a step prior to the application.

Although innumerable amines have been proposed to aminate glyphosate, and to obtain a water-soluble salt, and with sufficient herbicidal capacity to have commercial interest, the preferred amine is iso-propylamine.

Regardless of the lapse between the promotion and disclosure of the substitution of Glyphosate for saline Glyphosates, this aspect of agrochemicals has been satisfied by the generalized use of the iso-propylamine monosalt, whereof there is abundant information. In contrast, little information exists about the possibilities of other amine salts in the literature, and specially, no specific information exists about the Glyphosate triazolamine salt.

At present, the amination of glyphosate with triazolamine, or 1H-1,2,4-triazol-3-yl-amine, as is named by IUPAC, a heterocyclic compound with a five atom ring, where three of such are nitrogen and an amino substituent en carbon 3, from the following formula: 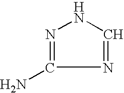
This triazolamine compound is also known as a non-selective systemic herbicide, that is absorbed by the leaves and the roots. It is used or applied to control perennial and annual grasses, broad foliaged herbals in fruit plantations and bushes in vegetable gardens, vineyards, and olive plantations, under ornamentation trees and bushes, in tree nurseries, in crop stubble, and on unused land, and other non-cultivated areas such as roads, railroads, industrial areas, and the like. It is used for total herbicide control before sowing or planting different crops. It is also used to control aquatic plants in swamps, drainage ditches, and the like.

It is used as an exclusive formulation, or together with other herbicides, such as diuron, atrazine, simazine, and also glyphosate salts.

In short, the triazolamine glyphosate salt is not disclosed specifically in the literature, and neither are its unexpected features related to what is known in the art, specially the triazolamine physical mixtures with glyphosate salts.

### DESCRIPTION OF THE INVENTION

### SUMMARY OF THE INVENTION

The purpose of the present invention is to revaluate the application of other N-(phosphonomethyl)-glycine or Glyphosate salts in the agrochemical field, particularly triazolamine salts, specially the triazolamine monosalt, compared to the other commonly applied salts, specially the most used iso-propylamine monosalt (IPAM).

What is proposed in the present application allows the commercial availability of the 1H-1,2,4-triazole-3-yl-amine N-(phosphonomethyl)-glycine salt (Glyphosate triazolamine), with the formula: 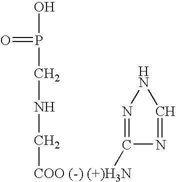
which is a highly hygroscopic cream-white solid, with molecular weight 253.153, and minimal formula C₅H₁₂N₅O₅P, with percentage composition C: 23.7%, H: 4.7%, N:27.7%, O: 31.6%, and P:12.3%. It has a melting point of (122±1)° C., and it is highly soluble in water, but it is insoluble, or very little soluble in alcohol, ketone, and aromatic solvents. The aqueous 10% w/w solution of the salt has pH 3.2.

The Glyphosate triazolamine salt is useful to prepare phytotoxic compositions, or their concentrate solutions, wherefrom it is possible to formulate in situ” aqueous solutions by diluting with water, for the same purposes, and with unexpected higher efficacy than formulations prepared only with a glyphosate salt such as IPAM, or the physical glyphosate mixtures with other herbicides, being additionally less toxic to humans and animals.

The main subject of this invention thus comprises a N-(phosphonomethyl)-glycine (glyphosate) salt, particularly the 1H-1,2,4-triazol-3-yl-amine N-(phosphonomethyl)-glycine monosalt (Glyphosate triazolamine salt) as “per se” phytotoxic agent.

Another subject of the present invention is to provide liquid or solid, particulated, powdered or granulated concentrate compositions, water soluble, comprising the Glyphosate triazolamine salt as phytotoxic agent, and including, additionally, at least one of the following additives: adjuvants, humidifiers, and tensioactive agents. Such concentrates allow the transportation and distribution of the active agent, without the extra charge on transportation costs, due to the dead or inert load represented by voluminous diluents, as is the case, for example with the water in conventional MIPA formulations. Besides, the concentrate compositions according to the invention, can be stored and carried in bags or cans, at substantially lower cost that is the case of massive transport of MIPA in trunks or even in bulk. Besides, they allow formulating “in situ” ready-to-use phytotoxic compositions by dissolving them in water, or mixing them with inert powdered diluents.

Another subject of this invention are phytotoxic preparations containing de N-(phosphonomethyl)-glycine triazolamine salt, prepared by dilution in water or with inert powdered diluents, of such Glyphosate triazolamine salt or the mentioned concentrate compositions thereof.

It is yet another subject of the present invention a method to combat weeds in a culture, comprising the application of the aforementioned phytotoxic formulation to the weeds present in a crop. Additionally, the method comprises the previous stage of preparing the phytotoxic formulation form a concentrate composition of the active compound such as the one disclosed. The application is done prior to or after the seed-planting, preferably always before the emergence of the crop. The control of weeds in a fruit tree plantation can also be carried out through this method.

### DETAILED DESCRIPTION OF THE INVENTION

The term “phytotoxic”, as used in the present, refers to materials effectively controlling all the plant in a given focus, or selectively controlling the growth of one or more species of plants in the presence of other plants. Likewise, “phytotoxic” and “phytotoxicity” are used to identify global and selective control activity of the compounds and compositions of this invention.

The term “control”, as used in the present, includes the meanings of killing; inhibit growth, reproduction, and development; and eliminate, destroy, or otherwise diminish the occurrence and activity of plants, being applicable to any of the actions set forth, or any of such combinations.

The term “plant”, as used en the present, means earthly and aquatic plants.

The term “earthly plant” includes germinating seeds, emerging shoots, and herbal vegetation, including roots and the parts found above the ground, likewise established woody plants.

The term “aquatic plant” means algae, and higher aquatic plants. The term “higher aquatic plant” means aquatic plants botanically higher than algae, and includes vegetative organisms growing on water, wherein most of such organisms are normally found immersed in a substantial proportion, for example, roots, such as Lemna, leaves, such as Vallisneria, or whole plants, such as Anacharis. Thus, the term “higher aquatic plant” includes all water plants, either normally floating freely in environmental water, such as Salvinia, or immersed species normally rooted in earth, such as Vallisneria, and species seemingly growing normally in all aspects, being freely floating, or rooted, such as Anacharis, or Alternanthera.

The term “tensioactive agent” means humidifying agents, dispersing agents, suspension agents, and emulsifying agents. Anionic, cationic, and non-ionic agents can equally easily be used.

The Glyphosate triazolamine salt, or N-(phosphonomethyl)-glycine triazolamine mono-salt of the present invention, hereinafter referred to indistinctly as N-(phosphonomethyl)-glycine mono-triazolamine, or Glyphosate triazolamine mono-salt, with the following formula: 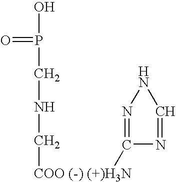
is a highly hygroscopic, cream-white solid, with molecular weight 253.153, and minimal formula C₅H₁₂N₅O₅P, with percentage composition C: 23.7%, H: 4.7%, N:27.7%, O: 31.6%, and P:12.3%. It has a melting point of (122±1)° C., and it is highly soluble in water, but it is insoluble, or very little soluble in alcohol, ketone, and aromatic solvents. The aqueous 10% w/w solution of the salt has pH 3.2.

The phytotoxic activity of the Glyphosate triazolamine mono-salt is higher and faster under the same conditions as the presented or obtained with the compositions of other herbicides, specially the N-(phosphonomethyl)glycine iso-propylamine mono-salt, and the mixtures thereof with other herbicides, as has been shown by experiments or “field assays” further detailed later, in Examples.

The concentrate product or composition, in accordance with another subject of this invention, is presented in liquid or powdered form, as water soluble granules or pellets, combined with adjuvancts, or humidifying additives and/or dispersing or emulsifying agents, according to the type of applicable preparation or formulation. Obviously, water is the most convenient solvent when formulating liquid preparations, being solutions or emulsions and dispersions. The concentrate compositions of the N-(phosphonomethyl)-glycinate triazolamine salt, according to the present invention, do not depend on a specific class of humidifying agents. Humidifiers, and also dispersing or emulsifying, anionic, or cationic, and non-ionic agents are indistinctly applicable.

Powdered or granulated compositions or preparations of the present invention may also be formulated as dry products or preparations thereof, to be atomized by dilution of such compositions, or the Glyphosate triazolamine salt with solid, inert diluents, known as “extensors”.

As is habitual in agrochemical practice, the powdered or granulated compositions of the present invention may be formulated with additional bioactive components, such as fertilizers, for example, urea and/or insecticides, for example carbamates, triazines, acetanilides, and the like.

The phytotoxic compositions of this invention, including the concentrates thereof requiring dilution before being applied on plants, contain at least one active ingredient and an auxiliary, in liquid or solid form. The compositions are prepared by mixing the active ingredient with an auxiliary, including diluents, extensors, carriers, conditioning agents, humidifying agents, emulsifying agents, and dispersing agents, in order to provide for compositions in solid form as finely divided particles, pastilles, solutions, dispersions, or emulsions. Thus, the active ingredient may be used with an auxiliary such as a finely divided solid, a liquid of organic origin, water, a conditioning agent, a humidifying agent, a dispersing agent, an emulsifying agent, or any adequate combination thereof. From an economic and convenience point of view, the preferred diluent is water.

The phytotoxic compositions of this invention, particularly liquids and insoluble powders, preferably contain one or more tensioactive agents as conditioning agent, in sufficient amounts for the given composition to be easily dispersible in water or oil. The incorporation of a tensioactive agent in the compositions improves substantially their efficacy. The preferred humidifying agents are alkyl-benzene-and alkylnaphtalenesulphonates, ethoxylated fatty alcohols, sulphate or sulphonate fatty alcohols, acid amines or amides, sodium iso-cyanate long chain acid esters, sodium sulphosuccinate acid esters, sulphate or sulphonate fatty acid esters, petroleum sulphonates, sulphonate plant oils, bi-terciary acethylene glycols, alkyl-phenol polyoxyethylene derivatives, particularly iso-octylphenol, and nonylphenol, and polyoxyethylene derivatives of higher mono-fatty acid hexytol anhydride esters, for example, sorbitan. Preferred humidifiers are, for example, nonylphenol-polyethoxilates or lamyl-sulphonates, for example, the sodium salt, among others.

Preferred dispersing agents are methyl-cellulose, polyvinyl alcohol, sodium ligninesulphonates, polymeric alkyl-naphtalenesulphonates, sodium naphtalenesulphonates, polymethylene bis-naphtalenesulphonates, and sodium N-methyl-N-(long chain acid) laureates. Among the most preferred dispersing agents are poly-vinyl-alcohol, methyl-cellulose, and sodium naphthalenesulphonate mentioned.

Water-dispersible powdered compositions can be produced with one or more active ingredients, an inert solid extensor, and one or more humidifying and dispersing agents. Usually, solid inert extensors are of mineral origin, such as natural clays, diatom-earths, and synthetic minerals derived form silica, and the like. Examples included of such extensors are kaolinite, attapulgite clay, silica, synthetic magnesium silicate, and diatom-earth. Most preferred extensors are kaolinite, attapulgite, silica, and diatom-earth, in variable ratio, according to the final formulation type.

The water-dispersible powder of this invention usually contains about 5 to 95 parts in weight of the active ingredient, the Glyphosate triazolamine salt, about 0.25 to 25 parts in weight of humidifying agent, and 4.5 to 94.5 parts in weight of inert solid extensor, all parts expressed in weight of the total composition. When required, o.1 to 2 parts in weight of the solid inert extensor may be replaced by a corrosion inhibitor, or a foaming agent, or both.

Aqueous suspensions may be prepared by mixing together and grinding an aqueous mud of an water-soluble active ingredient in the presence of dispersing agents, in order to obtain a concentrate mud of finely divided particles. The resulting aqueous and concentrate suspension is characterized by its extremely small particle size, to get a very uniform covering when diluted and sprayed.

Emulsifying oils are usually solutions of the active ingredient in solvents non-mixable in water, or partially mixable in water, together with a tensioactive agent. Adequate solvents for the active ingredient of this invention include carbohydrates and ethers, esters, and ketones non-mixable in water. Generally, the compositions of emulsifying oil contain from 5 to 95 parts of active ingredient, from 1 to 50 parts of tensioactive agent, and form 4 to 94 parts of solvent, where all parts are expressed in weight, referred to total weight of emulsifying oil.

Although the compositions of the present invention may also comprise fertilizers, phytotoxic, and plant growth regulators, pesticides, and the like, used as auxiliaries or combined with any of the aforementioned auxiliaries, all the compositions of this invention are preferred alone in sequence treatments with the other phytotoxics, fertilizers, and the like, in order to obtain maximum effect. For example, the field could be sprayed with a composition of this invention before or after being treated with fertilizers, other phytotoxics, and the like. The compositions of this invention may also be mixed with other materials, for example fertilizers, other phytotoxics, and the like, and be applied in only one application. The chemical products useful combined with the active ingredients of this invention, either simultaneously or sequentially, include, for example, triazines, ureas, carbamates, acetamides, acetanilides, uraciles, acetic acids, phenols, thiolcarbamates, triazoles, benzoic acids, nitrites, and the like, such as:
3-amine-2,5-dichloro-benzoic acid,
2-methoxy-4-ethylamine-6-iso-propylamine-s-triazine,
2-chloro-4-ethylamine-6-iso-propylamine-s-triazine,
2-chloro-N,N-diallyl-acetamide,
2-chloro-allyl diethyl-dithiocarbamate,
N′-(4-chloro-phenoxy)-phenyl-N,N-dimethylurea,
1,1′-dimethyl-4,4′-bipyridinium dichloride,
iso-propyl m-(3-chlorophenyl)-carbamate,
2,2-dichloropropionic acid,
S-2,3-dichloroallyl N,N-di-iso-propyl thiolcarbamate,
2-methoxi-3,6-dichlorobenzoic acid,
2,6-dichloro-benzonitrile,
N,N-dimethyl-2,2-diphenyl-acetamide,
6,7-dihydro-dipyride(1,2-a:2′,1′-c)-pyrazidinium salt,
3-(3,4-dichloro-phenyl)-1,1-dimethyl-urea,
4,6-dinitro-o-sec-butyl-phenol,
2-methyl-4,6-dinitro-phenol,
ethyl N,N-dipropyl-thiolcarbamate,
2,3,6-trichloro-phenyl-acetic acid,
5-bromo-3-iso-propyl-6-methyl-uracyl,
3-(3,4-dichloro-phenyl)-l-methoxy-1-methylurea,
2-methyl-4-chloro-phenoxy-acetic acid,
3-(p-chloro-phenyl)-1,1-dimethylurea,
1-butyl-3-(3,4-dichloro-phenyl)-1-methylurea,
N-a-naphtylphtalamic acid,
1,1′-dimethyl-4,4′-dipyridinium salt,
2-chloro-4,6-bis-(iso-propylamino)-s-triazine,
2-chloro-4,6-bis-(ethylamine)-s-triazine,
2,4-dichloro-phenyl-4-nitrophenylic ether,
α,α,α-trifluoro-2,6-dinitro-N,N-dipropyl-p-toluidine,
S-propyl dipropyl-thiol-carbamate,
2,4-dichloro-phenoxy-acetic acid,
N-iso-propyl-2-dichloro-phenoxi-acetic,
2′,6′-diethyl-N-methoxy-methyl-2-chloro-acetanilide,
acid metarsonate mono-sodium,
metarsonate di-sodium, and
N-(1,1-dimethyl-propynyl)-3,5-dichlorobenzamide.

Useful fertilizers combined with active ingredients include, for example, ammonium nitrate, urea, potash, and super-phosphate.

In accordance with this invention, it has been found that the growth of germinating seeds, emerging shoots, maturing and established woody and herbal vegetation, and aquatic plants, may be controlled by exposing the shoots emerging from the portions above the ground of the maturing and established vegetation, or aquatic plants, to the action of an effective amount of the Glyphosate triazolamine salt.

The Glyphosate triazolamine salt may be used alone, as a mixture of two or more compounds, or as mixtures with an auxiliary. This compound is effective as post-emerging phytotoxic and herbicide, for example, as selective growth control of one or more species of monocotyledons and/or one or more species of dicotyledons, in the presence of other monocotyledons and/or dicotyledons. Additionally, this compound presents a broad scope activity, that is, it controls the growth of a broad variety of plants, including, but without any limitation, ferns, coniferous such as pines, firs, and the like, aquatic plants, monocotyledons, and dicotyledons.

The compositions of this invention are extremely useful in minimal crop culture methods. Thus, for example, in those cases when it is desirable to plant an area covered with weeds, or otherwise covered with plants, with maize, or the like without plowing, or otherwise mechanically prepare a seed bed, the crop seed may be sown directly combining a previous application, or subsequent to a composition of this invention, in order to kill the growth of unwanted vegetation, whenever the composition is preferably applied before the emergence of the crop plant.

The compositions of this invention are also useful in renovation or conversion procedures of grounds covered with grass (lawn, alfalfa, pasture, and the like.) Thus, for example, in such situations in which a turf, or part of such is overdeveloped with unwanted plant species, the plants in the area may be sprayed with a phytotoxic composition of this invention, in order to control all growing plants, and approximately 2 to 24 hours later, depending on the environmental conditions, etc., the desired species may be sown in de decaying vegetation. When a seed bed is to be prepared, preferably about 2 to 3 weeks must pass between the treatment and the preparation of the seed bed, in order to provide for enough time for the composition to be assimilated by all parts of the unwanted plants. In an alternative method of turf renovation, the area may be sown and immediately sprayed with the composition of this invention.

In any method, the seeds fall among the vegetation, and as the sprayed plants wither and die, they act as a nutrient and humidity retention layer where the seeds may germinate. This method is particularly useful in the renovation of sown parcels or green golf courts or passages, since the herbicidal effect of the compositions of this invention may be affected by the contact with the ground. Thus, the seeds on the ground may germinate and grow without being affected by the spraying of the unwanted plants, before the moment when the seed really germinates.

The compositions of this invention provide a broad weed control spectrum, and are also extremely useful as general herbicides, likewise to control unwanted plants in vegetable gardens, tree plantations, and various crops. For example, it has been found that by directing an aspersion of the compositions of this invention towards the unwanted plants, while specially preventing this aspersion from coming in contact with the leaves of the trees, these unwanted plants are controlled, while no harm is done to the trees. In such directed aspersion, the aspersion may fall on the woody portion of the fruit tree, or any other tree, without causing any apparent effect. Thus, the directed aspersion control method is useful in cultures such as plantations, that is, rubber, coffee, bananas, tea, mate, and the like, and in fruit orchards such as citrus, apples, peaches, pears, nuts, olives, and in vineyards, and blackberry cultures, and in seedbed cultures, in order to control unwanted plants; and in crops such as cotton, soybean, sugar cane, and the like.

The compositions of this invention are also useful for weed control between crop seasons, for renovation of old seed beds, or the like.

To apply the compositions of this invention on plants wanted to be controlled, it has been found desirable that the plant emerges from the ground, and still more desirable that the plant is, at least, in the two-leave stage, in order to obtain maximum effect. It has been found that when the plants that are to be controlled have a developed portion above the ground or water, and the portion of the plant above the ground or water has come in contact with the herbicidal compositions of this invention in appropriate relations, the herbicide translocates to kill the parts of the plant that are beyond the ground or the surface of the water.

Limited selectivity may be obtained in crops such as cotton, soybeans, sugar cane, and similar crops, by directing the aspersion of a composition of this invention, at a selected concentration, to the vegetation surrounding the base of such plants, with minimum aspersion contact with the leave portions of such crop plants. Directed aspersion may be done with or without a protecting device to prevent the aspersion contact with the leaves of such crop plants.

A complete list of some of the species of plants being controlled with the compositions of the present invention is provided as follows:

| | |
|---|---|
| Medicago sativa | Poa annua |
| Lolium multiflorum | Hordeum vulgare |
| Hordeum murinum | Galium aparine |
| Alopecurus tenuis | Plantago lanceolata |
| Phaseolus vulgaris var. humilies | Mollugo verticillata |
| Daucus carota var. Sativa | Portulaca oleracea |
| Stellaris media | Zea mays |
| Agrostemma githago | Spergula arvensis |
| Gossypium hirsutum | Saponaria vaccaria |
| Agropyron cristatum | Cucumis sativus |
| Rumex crispus | Eriochloa gracilis |
| Paspalum dilatatum | Camelina microcarpa |
| Amsinckia intermedia | Linum usitatissimum |
| Setaria faberii | Ambrosia trifide |
| Setaria viridis | Lithospermum officinale |
| Secale cereale | Sisymbrium officinale |
| Lamium amplexicaule | Brassica juncea |
| Datura stramonium | Avena sativa |
| Arachis hypogaea | Pisum sativum |
| Solanum tuberosum | Sida spinosa |
| Cyperus rotundus | Polypogon monspeliensis |
| Raphanus sativus | Ambrosia artemisiifolia |
| Rottboellia exaltata | Brassica napus |
| Beta vulgaris | Oryza sativa |
| Amarantus retroflexus | Poa trivialis |
| Cenchrus pauciflorus | Rumex acetosella |
| Cassia obtusifolia | Andropogon saccharoides |
| Zea mays var. Saccharata | Fagopyrum tataricum |
| Lycopersicon esculentum | Citrullus vulgaris |
| Sorghum bicolor | Brassica kaber var. |
| | pinnatifida |
| Avena fatua | Erigeron canadensis |
| Plantago lanceolata | Trifolium pratense |
| Dactylis glomerata | Daucus carota |
| Solanum carolinense | Solanum elsegnifolium |
| Franseria tormentosa | Poa pratensis |
| Festuca arundinaceaee | Festuca rubra |
| Agrostis spp | Cynodon dactylon |
| Panicum dichotomiflorum | Commelina diffusa o communis |
| Pennisetum clandestinum | Paspalum spp. |
| Mikania cordata | Ottochloa nodosa |
| Imperata cylindrica | Axonopus compressus |
| Scleria bancara | Commellina nudiflora |
| Eleucine indica | |

Preferably, the main species of plants being controlled through de compositions of this invention are the following:

Annual gramineous:
Echinochloa colonum (barnyard grass, jungle rice)
Echinochloa crus-galli (water grass, barnyard millet)
Bromus unioloides (rescuegrass, upright brome)
Setaria spp. (foxtail)
Digitaria spp. (summer grass, finger grass)

Annual latifoliate:
Amarantus spp. (blite)
Chenopodium spp. (pigweed, goosefoot)
Datura ferox (long spined thornapple)
Polygonium convolvulus (wild buckwheat)
Polygonium aviculare (knotgrass)
Bidens pilosa (hairy beggarticks)

Perennial herbals:
Sorghum halepense (Aleppo grass, Johnson grass)
Cynodon dactylon (couch grass, Bermuda grass, green couch)
Cyperus rotundus (nutgrass, purple nutsedge)
Panicum maximum (Guinea grass, green panic)
Wedelia glauca (sunchillo)

When operating in accordance with the present invention, an effective amount on the Glyphosate triazolamine salt is applied to the portions of the plants that are above the ground. Liquid and particulate solid herbicidal compositions may be applied on the proportions of plants that are above the ground through conventional methods, for example through powder devices, mechanical and manual aspersing devises, and aspersing powder devices. The compositions may also be applied as fine powder or aspersion from airplanes, due to their effectiveness in low dosages. The herbicidal components are usually applied on aquatic plants by aspersion on the area that wants to be controlled.

The application on the plant of an effective amount of the compounds of this invention is essential and critical for the practice of the present invention. The exact amount of employed active ingredient depends on the desired response in the plant, and on other factors such as the species of the plant, and the amount of rainfall. In the treatment of leaves for the control of plant growth, the active ingredients are applied in amounts from 0.0112 kg to 22.4 or more kg per hectare. In applications for the control of aquatic plants, the active ingredients are applied in amounts from 0.01 ppm to 1,000 ppm, relative to the aqueous environment. An effective amount for phytotoxic or herbicidal control is the necessary amount for global or selective control, that is, a phytotoxic or herbicidal amount of the compound. It is believed that an expert in the art may easily determine the teachings of this document, including the examples, and the approximate application ratio.

The compositions of this invention are also useful as crop auxiliaries in many cultures. For example, the crop may be sprayed with the compositions of this invention, in order to reduce the volume of unwanted material, and facilitate the crop harvest. These crops are, for example, peanut, soybean, and root cultures such as potato, beetroot, sugar beet, and the like.

The following examples and assays describe how to obtain the Glyphosate triazolamine salt, haw to prepare the compositions and formulations of such Glyphosate triazolamine salt as active compound, and the results of the field assays. In the following Examples illustrating the invention, and through the descriptive report, the parts and percentages are expressed in weight, unless otherwise indicated.

### EXAMPLES

### Example 1

### PREPARATION OF DE N-(PHOSPHONOMETHYLGLYCINATE)1H-1,2,4-TRIAZOL-3-YLAMINE SALT(GLYPHOSATE TRIAZOLAMINE SALT)

In a 500 ml glass flask provided with refrigerant, thermometer, stirrer, heating plate and trap for azeotropic distillations (Dean and Stark), 60.0 g of water are introduced, and then, 60.0 g of acid Glyphosate. It is stirred until obtaining a homogeneous suspension, and 29.8 g of trizaloamine are added. Once the Glyphosate triazolamine salt is obtained (pH 3.5), 80.0 g of toluene are added. Then, the water-toluene azeotrope is vacuum distilled, regulating pressure to maintain boiling temperature from 55 to 60° C. Toluene must be replaced in the flask until all the water is eliminated. Once no more water is distilled, it is cooled to room temperature, and the toluene suspended Glyphosate triazolamine salt is obtained, and separated by filtration. The crystals obtained are washed in ethanol and dried in oven at 40° C. Eighty g of a dry product are obtained as an highly hygroscopic off-white solid with:
Molecular weight 253.153
Minimal formula C₅H₁₂N₅O₅P.
Percentage composition C: 23.7%; H: 4.7; N:27.7%; O: 31.6%; and P: 12.3%.
Melting point (122±1)° C.

### Example 2

### PROCESS FOR OBTAINING COMPOSITIONS AND FORMULATIONS OF THE N-(PHOSPHONOMETHYLGLYCINATE)1H-1,2,4-TRIAZOL-3-YLAMINE SALT(GLYPHOSATE TRIAZOLAMINE SALT) AS ACTIVE COMPOUND

a) Process of Preparing a Concentrate Liquid Composition of the Glyphosate Triazolamine Salt Containing 360 g of Glyphosate per Liter of Finished Product:

In a stainless steel or glassy reactor of 1,000 dm3 operative capacity, provided with stirring and heating devices such as serpentines or a shirt for vapor circulation, a 337 kg (1.89 kmol) 95% acid glyphosate suspension in 300 kg of water is prepared. To aminate the suspended acid Glyphosate, up to 216 kg (4.44kmol) of 95% technical triazolamine slowly, and under constant stirring. During the addition of triazolamine, a reduction of the temperature occurs, due to the endotermic reaction. The temperature must be kept from 15° C. to 40° C. Since Glyphosate is practically non-soluble in water, and triazolamine is quite soluble, the stability of the finished product formulation depends on pH. Thus, a 4.5 pH is considered final neutralization point. Then, 130 kg of coconut amidopropyl oxid tensioactive (for example, of the commercial brand ZAP), and 1 kg of the silicone emulsion are added. Finally, it is brought to volume with water, and 1,000 dm³ are obtained of a product with a 48% of Glyphosate triazolamine salt, with a density from 1.215 to 1.225 g/cm³.

| Component | Amount (kg) |
|---|---|
| Initial water | 300 |
| Glyphosate 95% | 337 |
| Triazolamine 95% | 216 |
| Tensioactive (ZAP) | 130 |
| Final water | Up to 1.000 dm³ |

b) Process of Preparing a Liquid Concentrate Composition Employing 85% Glyphosate.

Using 85% Glyphosate as starting material, the process is the same as the former example, but the amounts of each component are as follows:

| Component | Amount (kg) |
|---|---|
| Initial water | 250 |
| Glyphosate 85% | 376 |
| Triazolamine 95% | 216 |
| Tensioactive (ZAP) | 130 |
| Final water | Up to 1.000 dm³ |

c) Preparation of a Higher Concentrate Glyphosate Triazolamine Salt Composition in Solid Form:

To obtain a higher concentration composition, a powdered composition is prepared. In a stainless steel powder mixer of 100 kg useful capacity, 57.8 kg of 95% Glyphosate, 37.2 kg of 95% triazolamine, and 5 kg of 90% sodium naphtalenesulphonate are mixed to obtain homogeneity.

| Component | Amount (kg) |
|---|---|
| Glyphosate 95% | 57.8 |
| Triazolamine 95% | 37.2 |
| Na naphtalenesulphonate 90% | 5 |

Thus, 100 kg of a powdered composition of 62% concentrate Glyphosate triazolamine salt is obtained.

d) Preparation of the Glyphosate Triazolamine Salt Formulations.

The formulations ready to be used are prepared from the former compositions by diluting or dissolving it in water, up to a useful concentration.

### Example 3

Field Observations on Different Glyphosate Formulations Activity Rate

PURPOSE: Assess the glyphosate control rate as 48% iso-propylamide salt, equivalent to 36% of 100% acid, GMIPA, (Squadron, Roundup), and glyphosate as 48% triazolamine salt, equivalent to 32% of 100% acid (GAZOL).

Materials and Methods

Products were applied on a plot with maize stubble, preparing it for sowing wheat, where most abundant weeds were Aleppo grass (Sorghum halepense), water grass, jungle rice (Echinochloa crusgalli, Echinochloa colonum), and Bermuda grass (Cynodon dactylon).

The assessment was performed visually on 3, 4, 5, 8, and 10 days after application for jungle rice, and Aleppo grass, and 4,7,10, and 14 days for Bermuda grass, where the obtained effects were recorded and identified as follows: beginning of the effect (BE), death of the plant (DP), and without symptoms (WS).

TREATMENTS PERFORMED

| TREAT. No. | COMMERCIAL PRODUCT | DOSAGE (cm³/ha) |
|---|---|---|
| 1 | GMIPA (resting) | 5,000 |
| 2 | Glyphosate triazolamine salt | 5,000 |
| 3 | SULPHOSATE 58% (ZENECA SA) | 5,000 |
| 4 | SQUADRON 24% | 10,000 |
| | (MONSANTO SA) | |
| 5 | ROUNDUP 48% (MONSANTO SA) | 5,000 |
| Control | NONE | None |

Results

Control of jungle rice and Aleppo grass

| TREAT. | 3 DAYS | 4 DAYS | 5 DAYS | 8 DAYS | 10 DAYS |
|---|---|---|---|---|---|
| 1 | WS | WS | BE | BE | BE |
| 2 | BE | BE | DP | DP | DP |
| 3 | BE | BE | BE | DP | DP |
| 4 | BE | BE | BE | BE | BE |
| 5 | WS | WS | BE | BE | BE |

A higher rate is observed with treatments 2 and 3, after 3 days notorious symptoms of chlorosis and paleness appear in the shading of the plants.

Control of Bermuda grass

| TREAT. | 4 DAYS | 7 DAYS | 10 DAYS | 14 DAYS |
|---|---|---|---|---|
| 1 | WS | BE | BE | BE |
| 2 | BE | BE | DP | DP |
| 3 | BE | BE | BE | DP |
| 4 | WS | BE | BE | BE |
| 5 | WS | BE | BE | BE |

The control pattern seems similar than the given for the Aleppo grass and jungle rice case, but logically, partly delayed.

The 48% Glyphosate triazolamine salt appears faster in presenting the first symptoms, and much higher than 48% Glyphosate iso-propylamine salt (GMIPA and ROUNDUP)

It is important to point out that for the used dosages, and the evaluated weeds, the final controls for all treatments were similar, except SQADRON, with half the acid glyphosate, and was used on a double dosage.

The final results on control of present weeds were best at 10 days with Glyphosate triazolamine salt and sulphosate.

Conclusions

The Glyphosate triazolamine salt acts faster than its equivalent Glyphosate iso-propylamine salt, both as 48% salts.

Since the former contains 320 grams of 100% acid Glyphosate, and the latter contains 360 grams of such acid, a higher yield is detected, since a better result in rate and weed killing is obtained with a lesser content of the active Phytotoxic Glyphosate.

### Example 4

Comparative Evaluation Between Glyphosate Triazolamine Salt and the Mixture of Both Herbicides, with the Glyphosate Iro-Propylamine Salt as Control

GRAPHICAL LOCATION: EL TABACAL-ORAN-SALTA

APPLICATION: On renovation ground

TYPE OF TREATMENT: TOTAL (PRIOR TO CANE PLANTATION)

EXPERIMENTAL DESIGN: RANDOMIZED BLOCKS

AMOUNT OF REPETITIONS

| TREAT. | FORMULATION | DOSAGE/ha |
|---|---|---|
| 1 | Glyphosate triazolamine salt 48% | 3 liters |
| | as a salt (32% as an acid) | |
| 2 | Glyphosate triazolamine salt 48% | 4 liters |
| | as a salt (32% as an acid) | |
| 3 | RONDO (Glyphosate MIPA salt 48% − equiv. | Total: |
| | 36% as an acid) + WEEDAZOL | 6 liters |
| | (liquid 22.90% triazolamine) | |
| | (Mixture in trunk) | |
| 4 | RONDO | 4 liters |
| 5 | Control | No treatment |

Weeds Present at the Time of the Application

GRAMINEOUS

| Name | Status |
|---|---|
| Aleppo grass (Sorghum halepense) | Flower |
| Bermuda grass (Cynodon dactylon) | Growing |
| Blite (Amaranthus sp.) | Growing |
| Wild buckwheat (Polygonum convolvulus) | Growing |
| Nutgrass (Cyperus rotundus) | Flower |

APPLICATION KIT: CO₂

PASTILLES: 110.03

TYPE: TWIN JET

STAKE: 1

No. PASTILLES: 1

COVER ×PASSAGE: 1 meter

PRESSURE: 35 lbs/inch²

RATE/100 m: 0°

VOLUME PER HECTARE: 120 liters

Meteorogical Data at Time of Application

TEMPERATURE: 23° C.

RELATIVE HUMIDITY: 70%

CLOUDINESS: 0

ATMOSPHERIC PRESSURE: 710

WIND: 1, 5 km/hour

TYPE OF SOIL: Clayish, pH: 7,8

SURFACE HUMIDITY: No humidity

ASSAY OBSERVATIONS (*)

| | 5 DAYS | 15 DAYS | 30 DAYS |
|---|---|---|---|
| 1 | 4 | 7 | 9 |
| 2 | 4 | 7 | 10 |
| 3 | 4 | 6 | 8 |
| 4 | 3 | 5 | 8 |
| 5 | 100% weeds | 100% weeds | 100% weeds |

(*) CONTROL: Scale of numerical values used from (1) out of control, to (10) excellent control.

Observations

After 5 days, treatments 1, 2, and 3 showed more advanced signs of phytotoxicity. After 15 days, treatments 1 and 2 showed better behavior than the rest. After 30 days, a better control is evidenced through treatments 1 and 2, followed by 3, and finally 4.

Conclusions

The incorporation of triazolamine in the trunk mixture improves Glyphosate activity. The Glyphosate triazolamine salt obtained through the amination of glyphosate with triazolamine is higher than the mixture in a trunk of both active formulations, according to treatment 3. There are no significant differences between 3 and 4 liters/ha of the herbicide Glyphosate triazolamine salt 48% (32% as glyphosate acid) for the control of the existing weeds.

### Example No. 5

Comparative Demonstration of Similatity of Action Between Glyphosate Triazolamine Salt, and Glyphosate Iso-Propyl-Amine Salt (Both Products with the Same Amount of Acid Glyphosate per Liter)

GEOGRAPHIC LOCATION: Tunuyán-Mendoza.

Culture Data

Culture: Apple

Variety: Hybrid. Red Delicious.

Phenologic status: with fruits of 2 cm diameter.

Density: Traditional culture, plants at 8×8 m.

Sanitary status of the culture: Very good.

Climate Characteristics

Dry with 60% -70% of relative humidity, and temperatures between 20° C.-22° C. by the month of November.

Characteristics of the Plot

Type of soil: Frankly clayish

Soil humidity: Good.

WEEDS UNDER STUDY

| Common name | Scientific name | Stage of development |
|---|---|---|
| Aleppo grass | Sorghum halepensis | Cluster w/40% flowering |
| Bermuda grass | Cynodon dactylon | Vegetative stage w/20% |
| | | flowering |
| White aster | Wedelia glauca | Vegetative state w/30% |
| | | flowering |

Installation Data

Temperature: 21° C.

Relative humidity: 60%

Kit: CO₂ backpack

Waterflow: 215 liters/ha

Pressure: 46 lb/inch²

Peaks: 11003

Treatments:

| | | PRODUCT TO BE USED | |
|---|---|---|---|
| | | I.A. (100% acid) | |
| TREAT. No. | PRODUCT | P.C. (formulation) | |
| 1 | Control | — | — |
| 2 | Triazolamine salt with 36% | 1,440 g/ha | 4 l/ha |
| | acid glyphosate | | |
| 3 | Mono-ammonium salt with | 1,440 g/ha | 4 l/ha |
| | 36% acid glyphosate (Rondo | | |
| | Super) | | |

Observations: Only one dose of each product was tested in three repetitions, on areas of 2 m×8 m=16 m².

Assessments

AVERAGES OF BLOCKS A-B-C 38 days after application

| | COUNT | | |
|---|---|---|---|
| TREAT. No. | A | B | C |
| 0 | — | — | — |
| 1 | 65 | 70 | 75 |
| 3 | 68 | 70 | 70 |

AVERAGES OF BLOCKS A-B-C 51 days after application

| | COUNT | | |
|---|---|---|---|
| TREAT. No. | A | B | C |
| 0 | — | — | — |
| 1 | 85 | 80 | 90 |
| 3 | 85 | 88 | 88 |

AVERAGES OF BLOCKS A-B-C 99 days after application

| | COUNT | | |
|---|---|---|---|
| TREAT. No. | A | B | C |
| 0 | — | — | — |
| 1 | 95 | 90 | 98 |
| 3 | 95 | 95 | 95 |

References:

(A) Aleppo grass; (B) Bermuda grass; (C) Sunchillo

Conclusions:

Glyphosate triazolamine salt herbicide behaves similarly to the herbicide MIPA salt, with equal dosage of active principle used per hectare. Both were effective for the weeds studied at indicated dosage and conditions. No phytotoxicity to the fruit tree was observed.

### Example N° 6

Assessment of Different Glyphosate formulations for the Control of soy Weeds

GEOGRAPHICAL LOCATION: Timbues, Department of Iriondo, Province of Santa Fe.

OBJECTIVE: The subject of the present assay comprises the assessment of different Glyphosate formulations on annual and perennial weeds in a resistant soy crop.

Matherials and Methods:

Crop data were as follows:
Species: Soya
Variety: A-6443
See-planting time: Second.
Preceding crop: Wheat
Density of seeds planted: 33 grains/m²
Density of grown plants: 28 pl/m²
Space between furrows: 0.52 m.
Culture system: Direct seed-planting.
Phenologic status on application: R-4/5

The existing weeds were the following:

| Common name | Scientific name |
|---|---|
| Aleppo grass | Sorghum halepense |
| Bermuda grass | Cynodon dactylon |
| Blite | Amaranthus quitensis |
| Pigweed | Chenopodium album |
| Nutgrass | Cyperus rotundus |

Random blocks design was used, with four repetitions per treatment. The size of the parcels were: 4 m wide per 15 m long (60 m²), totaling 240 m² per treatment.

The product was applied with a carbon dioxide (CO₂) hand backpack, provided with four tips separated by 0.50 m each, with a plain fan-type 110 O₂ pastille. Applied volume was of 110 1/ha, at a pressure of 45 lb/cm²

The tested treatments were the following:

| TREAT. | | |
|---|---|---|
| No. | Commercial products | Dosage (in cm²/ha) |
| 1 | Glyphosate triazolamine salt | 2,000 |
| 2 | Glyphosate triazolamine salt | 3,000 |
| 3 | Rondo - glyphosate iso- | 2,500 |
| | propylamine salt | |
| 4 | Rondo - Glyphosate iso- | 5,000 |
| | propylamine salt | |
| 5 | Non-applied control | — |

The glyphosate triazolamine salt (GAZOL comprises 360 grams, as acid Glyphosate.

Rondo: Glyphosate iso-propylamine salt comprising 360 grams as acid Glyphosate.

The assessments were carried out visually by comparison with control non-applied parcels, and at 5, 10, 15, and 25 days after the application date en each case, where the intervals between each application from the beginning of the treatment were 5, 5, and 10 days, respectively.

Variance analysis (ANOVA) and Duncan Test were performed with the results obtained, in order to detect mean differences.

Results and Discussion

1—Controls of Blite, Pigweed, and Aleppo Grass

In order to control these weeds, treatments No. 1 and No. 3 must be analyzed, which respond to the appropriate control dosage. However, it is interesting to point out that treatment No. 2 showed a remarkable activity rate, statistically higher than the equivalent treatment No. 4.

From the data analysis, a 100% control at the end of the assay obtained from all the other treatments was observed, thus differences shall not be searched in this aspect, but in those shown in the first observations. Thus it must be mentioned that treatments No.1 and No.2 showed phytotoxicity problems on soy leaves, so the product Glyphosate triazolamine salt must be applied on a non-cultivated field, with weeds only.

In the assessment performed 15 days after de application, the only different treatment is No. 3 (Rondo), which is not a major problem, even when a minor control is not attained, observed within the context of the assay as a whole, and from an agricultural point of view.

2—Control of Bermuda Grass and Nutgrass

Although the total control obtained by higher dosages (Nos. 2-4) was expected, No. 2 stands out, due to its greater action rate.

As regards the final control, the 25 day assessment, the behavior of the lower dosage of Glyphosate triazolamine salt (No. 1) was statistically and agriculturally higher than an equivalent dosage treatment (No. 3), although in this case the weed control is partial, evidencing function differences.

Conclusions

All the treatments showed total control over blite (Amaranthus quitensis), pigweed (Chenopodium album), and Aleppo grass (Sorghum halepense). The higher dosage treatments (Nos. 2 and 4) attained total control over Bermuda grass (Cynodon dactylon) and nutgrass (Cyperus rotundus). Treatment No. 2 (Glyphosate triazolamine salt at 3,000 cm²/ha) showed highest action rate, over all existing weeds. Treatments Nos. 1 and 2 (Glyphosate triazolamine salt at 2,000 and 3,000 cm²/ha) showed phytotoxicity over soy crops, and must be applied only on non-cultured fields (before seed-planting, or chemical fallow). For all the presently shown, the addition of no other phytotoxic agent is needed.

TABLE NO. 1
Percentage of control over Blite, Pigweed, and
Aleppo grass.

| TREAT. | | Dosage (in | Control % after 5 days | | | |
|---|---|---|---|---|---|---|
| No. | Products | cm²/ha) | I | II | III | MEAN |
| 1 | Glyphosate | 2,000 | 60 | 55 | 60 | 58.33 |
| | triazolamine | | | | | |
| | salt | | | | | |
| 2 | Glyphosate | 3,000 | 100 | 90 | 95 | 95.00 |
| | triazolamine | | | | | |
| | salt | | | | | |
| 3 | Rondo | 2,500 | 70 | 70 | 70 | 70.00 |
| 4 | Rondo | 5,000 | 80 | 85 | 85 | 83.33 |
| 5 | Non-applied | — | — | — | — | — |
| | control | | | | | |

TABLE NO. 2
Percentage of control over Blite, Pigweed, and
Aleppo grass.

| TREAT. | | Dosage (in | Control % after 10 days | | | |
|---|---|---|---|---|---|---|
| No. | Products | cm²/ha) | I | II | III | MEAN |
| 1 | Glyphosate | 2,000 | 100 | 100 | 100 | 100.00 |
| | triazolamine | | | | | |
| | salt | | | | | |
| 2 | Glyphosate | 3,000 | 100 | 100 | 100 | 100.00 |
| | triazolamine | | | | | |
| | salt | | | | | |
| 3 | Rondo | 2,500 | 90 | 90 | 95 | 91.67 |
| 4 | Rondo | 5,000 | 100 | 100 | 100 | 100.00 |
| 5 | Non-applied | — | — | — | — | — |
| | control | | | | | |

TABLE NO. 3
Percentage of control over Blite, Pigweed, and
Aleppo grass.

| TREAT. | | Dosage (in | Control % after 15 days | | | |
|---|---|---|---|---|---|---|
| No. | Products | cm²/ha) | I | II | III | MEAN |
| 1 | Glyphosate | 2,000 | 100 | 100 | 100 | 100.00 |
| | triazolamine | | | | | |
| | salt | | | | | |
| 2 | Glyphosate | 3,000 | 100 | 100 | 100 | 100.00 |
| | triazolamine | | | | | |
| | salt | | | | | |
| 3 | Rondo | 2,500 | 95 | 90 | 100.00 | 95.00 |
| 4 | Rondo | 5,000 | 100 | 100 | 100 | 100.00 |
| 5 | Non-applied | — | — | — | — | — |
| | control | | | | | |

TABLE NO. 4
Percentage of control over Blite, Pigweed, and
Aleppo grass.

| TREAT. | | Dosage (in | Control % after 10 days | | | |
|---|---|---|---|---|---|---|
| No. | Products | cm²/ha) | I | II | III | MEAN |
| 1 | Glyphosate | 2,000 | 100 | 100 | 100 | 100.00 |
| | triazolamine | | | | | |
| | salt | | | | | |
| 2 | Glyphosate | 3,000 | 100 | 100 | 100 | 100.00 |
| | triazolamine | | | | | |
| | salt | | | | | |
| 3 | Rondo | 2,500 | 100 | 100 | 100 | 100.00 |
| 4 | Rondo | 5,000 | 100 | 100 | 100 | 100.00 |
| 5 | Non-applied | — | — | — | — | — |
| | control | | | | | |

TABLE NO. 5
Percentage of control over Blite, Pigweed, and
Aleppo grass. Data average by assessment date.

| | | Dosage | Control % after | | | |
|---|---|---|---|---|---|---|
| TREAT. | | (in | 5 | 10 | 15 | 25 |
| No. | Products | cm²/ha) | DAYS | DAYS | DAYS | DAYS |
| 1 | Glyphosate | 2,000 | 58.33 | 100.00 | 100.00 | 100.00 |
| | triazolamine | | E | A | A | A |
| | salt | | | | | |
| 2 | Glyphosate | 3,000 | 95.00 | 100.00 | 100.00 | 100.00 |
| | triazolamine | | A | A | A | A |
| | salt | | | | | |
| 3 | Rondo | 2,500 | 70.00 | 91.67 | 95.00 | 100.00 |
| | | D | B | B | A | |
| 4 | Rondo | 5,000 | 83.33 | 100.00 | 100.00 | 100.00 |
| | | | BC | A | A | A |
| 5 | Non-applied | — | — | — | — | — |
| | control | | | | | |

Within each column, the values followed with different capital letter differ in 1%.

Highly significant differences between treatments on days 5 and 10 after the application of products (F=25.90; p<0.01) and (F=13.83; p<0.01), respectively. On day 15, significant differences between treatments were found (F=2.15; p<0.05)

TABLE NO. 6
Percentage of control over Bermuda grass, and
Nutgrass.

| TREAT. | | Dosage (in | Control % after 5 days | | | |
|---|---|---|---|---|---|---|
| No. | Products | cm²/ha) | I | II | III | MEAN |
| 1 | Glyphosate | 2,000 | 60 | 50 | 50 | 53.00 |
| | triazolamine salt | | | | | |
| 2 | Glyphosate | 3,000 | 70 | 80 | 75 | 75.00 |
| | triazolamine salt | | | | | |
| 3 | Rondo | 2,500 | 30 | 30 | 40 | 33.33 |
| 4 | Rondo | 5,000 | 55 | 50 | 50 | 51.67 |
| 5 | Non-applied | — | — | — | — | — |
| | control | | | | | |

TABLE NO. 7
Percentage of control over Bermuda grass, and
Nutgrass.

| TREAT. | | Dosage (in | Control % after 10 days | | | |
|---|---|---|---|---|---|---|
| No. | Products | cm²/ha) | I | II | III | MEAN |
| 1 | Glyphosate | 2,000 | 75 | 90 | 90 | 85.00 |
| | triazolamine | | | | | |
| | salt | | | | | |
| 2 | Glyphosate | 3,000 | 100 | 100 | 100 | 100.00 |
| | triazolamine | | | | | |
| | salt | | | | | |
| 3 | Rondo | 2,500 | 60 | 50 | 50 | 53.33 |
| 4 | Rondo | 5,000 | 85 | 80 | 80 | 81.67 |
| 5 | Non-applied | — | — | — | — | — |
| | control | | | | | |

TABLE NO. 8
Percentage of control over Bermuda grass and
Nutgrass.

| TREAT. | | Dosage (in | Control % after 15 days | | | |
|---|---|---|---|---|---|---|
| No. | Products | cm²/ha) | I | II | III | MEAN |
| 1 | Glyphosate | 2,000 | 85 | 90 | 90 | 88.33 |
| | triazolamine salt | | | | | |
| 2 | Glyphosate | 3,000 | 100 | 100 | 100 | 100.00 |
| | triazolamine salt | | | | | |
| 3 | Rondo | 2,500 | 60 | 60 | 50 | 56.67 |
| 4 | Rondo | 5,000 | 100 | 100 | 100 | 100.00 |
| 5 | Non-applied | — | — | — | — | — |
| | control | | | | | |

TABLE NO. 9
Percentage of control over Bermuda grass and
Nutgrass.

| TREAT. | | Dosage (in | Control % after 25 days | | | |
|---|---|---|---|---|---|---|
| No. | Products | cm²/ha) | I | II | III | MEAN |
| 1 | Glyphosate | 2,000 | 85 | 90 | 90 | 88.33 |
| | triazolamine | | | | | |
| | salt | | | | | |
| 2 | Glyphosate | 3,000 | 100 | 100 | 100 | 100.00 |
| | triazolamine | | | | | |
| | salt | | | | | |
| 3 | Rondo | 2,500 | 60 | 60 | 50 | 56.67 |
| 4 | Rondo | 5,000 | 100 | 100 | 100 | 100.00 |
| 5 | Non-applied | — | — | — | — | — |
| | control | | | | | |

TABLE NO. 10
Percentage of control over Bermuda grass and
Nutgrass. Data average by assessment date.

| TREAT. | | Dosage | Control % after 10 days | | | |
|---|---|---|---|---|---|---|
| No. | Products | (in cm²/ha) | 5 DAYS | 10 DAYS | 15 DAYS | 25 DAYS |
| 1 | Glyphosate | 2,000 | 53.33 B | 85.00 BC | 88.33 B | 83.33 B |
| | triazolamine | | | | | |
| | salt | | | | | |
| 2 | Glyphosate | 3,000 | 75.00 A | 100.00 A | 100.00 A | 100.00 A |
| | triazolamine | | | | | |
| | salt | | | | | |
| 3 | Rondo | 2,500 | 33.33 D | 53.33 F | 56.67 D | 56.67 D |
| 4 | Rondo | 5,000 | 51.67 B | 81.67 B | 100.00 A | 100.00 A |
| 5 | Non-applied | — | — | — | — | — |
| | control | | | | | |

Within each column, values followed by different capital letter differ in 1%.

Highly significant differences exist between treatments on days 5, 10, 15, and 25 after the application of products (F=15.77; p<0.01) and (F=28.97; p<0.01), (F=64.26; p<0.01), and (F=104.43; p<0.01), respectively.

### Example No. 7

Assessment of Glyphosate Triazolamine Salt (LS) in Weed Control in a Peach Tree Orchard.

GEOGRAPHICAL LOCATION: Alvarez, Rosario Department, Province of Santa Fe.

PURPOSE: The purpose of the present assay is to assess the efficacy, with different dosage, of the Glyphosate triazolamine salt (LS) herbicide for the control of annual and perennial weeds in a peach tree orchard. Simultaneously, the activity of the aforementioned product with Glyphosate triazolamine salt (PS), commercially available Glyphosate, and the latter combined with 2,4-D were compared.

Materials and Methods:

The assays was performed in a peach tree orchard. The weeds present at the application time were as follows:

| | Scientific | | |
|---|---|---|---|
| Common name | name | Family and cycle | Size |
| Aleppo grass | Sorghum | Perennial | 40 to 50 cm |
| | halepense | gramineous | |
| | | (spring-summer) | |
| Bermuda grass | Cynodon | Perennial | 3 cm stolons |
| | dactylon | gramineous | |
| | | (spring-summer) | |
| Summer grass | Digitaria | Annual gramineous | 25 to 35 cm |
| | sanguinalis | (spring-summer) | |
| “Sunchillo” | Wedelia | Perennial compound | 15 to 18 cm |
| | glauca | (spring-summer- | |
| | | fall) | |
| Nutgrass | Cyperus | Perennial | 5 leaves |
| | rotundus | cyperaceous | |
| | | (spring-summer) | |

The used design was random blocks, with four repetitions per treatment, with 36.0 m² per parcel (3.0 m e, and 12.0 m long) coinciding with the treetop projection area, 1.5 m on each side of the plantation line.

The treatment performed were as follows:

| TREAT. | | DOSAGE (gr. or |
|---|---|---|
| No. | PRODUCTS | cm³pc/ha) |
| 1 | Glyphosate triazolamine salt (SL)* | 1,000 |
| 2 | Glyphosate triazolamine salt (SL) | 2,000 |
| 3 | Glyphosate triazolamine salt (SL) | 3,000 |
| 4 | Glyphosate triazolamine salt (SP) | 3,000 |
| 5 | 48% Glyphosate** | 3,000 |
| 6 | 48% Glyphosate | 5,000 |
| 7 | 48% Glyphosate + 2,4-D*** | 3,000 + 250 |
| 8 | 48% Glyphosate + 2,4-D | 5,000 + 250 |
| 9 | NOT CONTROLLED | — |

*Glyphosate triazolamine salt: 36% as acid.
**Glyphosate iso-propylamine salt: 48% as salt, 36% as acid.
***100% 2,4-D-butyl ester.
SL: Soluble liquid.
SP: Soluble powder.

The product was applied with a carbon dioxide (CO₂) hand backpack, provided with three tips separated by 0.50 m each. 80015 plain fan-type were used, with a volume of 120 1/ha, at a pressure of 27 lb/inches²

The assessments were carried out visually by comparison with control non-applied parcels, and at 3, 5, 7, and 15 days after the application date en each case.

Variance analysis (ANOVA) and Duncan Test were performed with the results obtained, in order to detect mean differences. With the same data, a Factorial Analysis of treatments by evaluation date was performed, in order to detect global differences during the total time period of treatment effect evaluation, and a result considering both action rate and final control was obtained.

| | | | REPETITIONS | | | | |
|---|---|---|---|---|---|---|---|
| TREAT | PRODUCTS | DOSAGE | I | II | III | IV | MEAN |
| 1 | Glyphosate | 1,000 | 30 | 40 | 40 | 40 | 37.50 |
| | triazolamine salt | | | | | | |
| | (SL) | | | | | | |
| 2 | Glyphosate | 2,000 | 50 | 50 | 50 | 50 | 50.00 |
| | triazolamine salt | | | | | | |
| | (SL) | | | | | | |
| 3 | Glyphosate | 3,000 | 50 | 50 | 50 | 50 | 50.00 |
| | triazolamine salt | | | | | | |
| | (SL) | | | | | | |
| 4 | Glyphosate | 3,000 | 60 | 70 | 70 | 60 | 50.00 |
| | triazolamine salt | | | | | | |
| | (SP) | | | | | | |
| 5 | 48% Glyphosate | 3,000 | 10 | 25 | 20 | 10 | 16.25 |
| 6 | 48% Glyphosate | 5,000 | 30 | 30 | 30 | 30 | 30.00 |
| 7 | 48% Glyphosate + | 3,000 + 250 | 40 | 40 | 40 | 40 | 40.00 |
| | 2,4-D | | | | | | |
| 8 | 48% Glyphosate + | 5,000 + 250 | 70 | 70 | 70 | 70 | 70.00 |
| | 2,4-D | | | | | | |
| 9 | CONTROL | — | 0 | 0 | 0 | 0 | 0.00 |

TABLE NO. 2
% OF AFFECTED WEEDS AFTER 5 DAYS

| | | DOS- | REPETITIONS | | | | |
|---|---|---|---|---|---|---|---|
| TREAT | PRODUCTS | AGE | I | II | III | IV | MEAN |
| 1 | Glyphosate | 1,000 | 60 | 65 | 60 | 60 | 61.25 |
| | triazolamine salt | | | | | | |
| | (SL) | | | | | | |
| 2 | Glyphosate | 2,000 | 85 | 80 | 90 | 80 | 83.75 |
| | triazolamine salt | | | | | | |
| | (SL) | | | | | | |
| 3 | Glyphosate | 3,000 | 90 | 90 | 95 | 90 | 91.25 |
| | triazolamine salt | | | | | | |
| | (SL) | | | | | | |
| 4 | Glyphosate | 3,000 | 100 | 90 | 100 | 90 | 95.00 |
| | triazolamine salt | | | | | | |
| | (SP) | | | | | | |
| 5 | 48% Glyphosate | 3,000 | 50 | 45 | 60 | 50 | 51.25 |
| 6 | 48% Glyphosate | 5,000 | 60 | 70 | 60 | 60 | 62.50 |
| 7 | 48% Glyphosate + | 3,000 + | 70 | 75 | 60 | 60 | 66.25 |
| | 2,4-D | 250 | | | | | |
| 8 | 48% Glyphosate + | 5,000 + | 70 | 70 | 75 | 70 | 71.25 |
| | 2,4-D | 250 | | | | | |
| 9 | CONTROL | — | 0 | 0 | 0 | 0 | 0.00 |

TABLE NO. 3
% OF AFFECTED WEEDS AFTER 7 DAYS

| | | DOS- | REPETITIONS | | | | |
|---|---|---|---|---|---|---|---|
| TREAT | PRODUCTS | AGE | I | II | III | IV | MEAN |
| 1 | Glyphosate | 1,000 | 60 | 65 | 60 | 60 | 61.25 |
| | triazolamine salt | | | | | | |
| | (SL) | | | | | | |
| 2 | Glyphosate | 2,000 | 85 | 80 | 90 | 80 | 83.75 |
| | triazolamine salt | | | | | | |
| | (SL) | | | | | | |
| 3 | Glyphosate | 3,000 | 90 | 95 | 95 | 90 | 92.25 |
| | triazolamine salt | | | | | | |
| | (SL) | | | | | | |
| 4 | Glyphosate | 3,000 | 100 | 90 | 100 | 90 | 96.25 |
| | triazolamine salt | | | | | | |
| | (SP) | | | | | | |
| 5 | 48% Glyphosate | 3,000 | 50 | 50 | 60 | 60 | 55.00 |
| 6 | 48% Glyphosate | 5,000 | 80 | 70 | 75 | 70 | 73.75 |
| 7 | 48% Glyphosate + | 3,000 + | 70 | 75 | 60 | 60 | 66.25 |
| | 2,4-D | 250 | | | | | |
| 8 | 48% Glyphosate + | 5,000 + | 80 | 70 | 75 | 90 | 78.75 |
| | 2,4-D | 250 | | | | | |
| 9 | CONTROL | — | 0 | 0 | 0 | 0 | 0.00 |

TABLE NO. 4
% OF AFFECTED WEEDS AFTER 15 DAYS

| | | DOS- | REPETITIONS | | | | |
|---|---|---|---|---|---|---|---|
| TREAT | PRODUCTS | AGE | I | II | III | IV | MEAN |
| 1 | Glyphosate | 1,000 | 60 | 65 | 60 | 60 | 61.25 |
| | triazolamine | | | | | | |
| | salt (SL) | | | | | | |
| 2 | Glyphosate | 2,000 | 85 | 85 | 90 | 80 | 85.00 |
| | triazolamine | | | | | | |
| | salt (SL) | | | | | | |
| 3 | Glyphosate | 3,000 | 100 | 95 | 100 | 95 | 97.50 |
| | triazolamine | | | | | | |
| | salt (SL) | | | | | | |
| 4 | Glyphosate | 3,000 | 100 | 100 | 100 | 100 | 100.00 |
| | triazolamine | | | | | | |
| | salt (SP) | | | | | | |
| 5 | 48% Gly- | 3,000 | 50 | 50 | 60 | 60 | 55.00 |
| | phosate | | | | | | |
| 6 | 48% Gly- | 5,000 | 100 | 90 | 100 | 90 | 95.00 |
| | phosate | | | | | | |
| 7 | 48% Gly- | 3,000 + | 70 | 75 | 60 | 60 | 66.25 |
| | phosate + | 250 | | | | | |
| | 2,4-D | | | | | | |
| 8 | 48% Gly- | 5,000 + | 100 | 95 | 95 | 100 | 97.50 |
| | phosate + | 250 | | | | | |
| | 2,4-D | | | | | | |
| 9 | CONTROL | — | 0 | 0 | 0 | 0 | 0.00 |

Results and Discussion:

Assessment 3 Days After the Application:

The assessment of the affected weed three days after the treatment application shows treatment No. 8 as the fastest presenting symptoms, which is logical, due to the fast visualization of 2,4-D effects on latifoliated, and of high dosage of Glyphosate on Cynodon dactylon.

Treatment No. 4 appears in second place, with a remarkable effect on Wedelia glauca, and Cyperus rotundus.

Treatment Nos. 3, 2, and 1 do not present statistical differences between each other, but are higher than the control reached by treatments based only on Glyphosate (Nos. 5, and 6), and Glyphosate at sub-dosage plus 2,4-D (No. 7); in the latter cases, due to the very low effect shown on Cynodon dactylon, and Cyperus rotundus.

According to the present assessment, there is a notorious statistical difference between treatment Nos. 4 and 3 (Glyphosate triazolamine salt at the same dosage, but with different formulation), but from an agricultural standpoint, such difference has little significance.

Assessment 5 Days After the Application:

In the present assessment, treatment Nos. 4 and 4 stand out, followed by No. 2. They show symptoms of effects on all the weeds, with notorious effect on Wedelia glauca, Sorghum halepense, and Digitaria sanguinalis.

Assessment 7 days after the application:

In the present assessment, treatment Nos. 3 and 4 achieve a remarkable level, with no statistical differences among them, and they are higher than the rest of the treatments.

Assessment 15 Days After the Application:

In the assessment performed seven days after the application, treatment Nos. 1, 2, 3, 4, 5, and 7 practically behaves equally than 15 days later, thus showing a control maximum.

Treatment Nos. 4, 3, 8, and 6 reached the highest final control levels, with no statistical difference among them.

The difference between the former treatments, and the rest appeared particularly in the Cynodon dactylon, Wedelia glauca, and Cyperus rotundus control, which was similar to the Sorghum halepense, and Digitaria sanguinalis control.

Result of the Factorial Analysis:

The present analysis takes into account the herbicidal activity during the total period of time of the evaluation (it averages the four assessments), in order to relate activity rate with final control. In such aspect, treatment No. 4 showed the best performance, followed by Nos. 3, 8, and 2 in the four highest rankings.

As regards the date factor, most treatments reached the best results as the assessment date was delayed. Exceptions are treatment Nos. 1, 5, and 7, which reach maximum control between five and seven days after the application.

Conclusions:

For the current assay conditions, the following conclusions were obtained:

Treatment Nos. 3, and 4 achieved a very good control level on all weeds.

Treatment NO. 2 achieved a very good control level of the present weeds, with the exception of Cynodon dactylon, where it was deficient.

Treatment No. 1 did not reach acceptable control levels.

Variance Analysis Among Treatments

Design of the experiment: Randomized blocks

Statistical analysis: Variance analysis (ANOVA) for a randomized bock design.

Mean difference: Duncan's test.

Program used: SAS System

Scheme 1: Affected weeds (in %) by the treatments 3, 5, 7,
and 15 days after the application.

| | | | Day 3 | Day 5 | Day 7 | Day 15 |
|---|---|---|---|---|---|---|
| Treatments | | | after | after | after | after |
| No. | Name | Dosage | Application | application | Application | application |
| 1 | Glyph. | 1,000 | 37.50 D | 61.25 D | 61.25 EF | 61.25 CD |
| | triazolamide | | | | | |
| | salt (SL) | | | | | |
| 2 | Glyph. | 2,000 | 50.00 C | 83.75 B | 83.75 B | 85.00 B |
| | triazolamide | | | | | |
| | salt (SL) | | | | | |
| 3 | Glyph. | 3,000 | 50.00 C | 91.25 A | 92.50 A | 97.50 A |
| | triazolamide | | | | | |
| | salt (SL) | | | | | |
| 4 | Glyphosate | 3,000 | 65.00 B | 95.00 A | 96.25 A | 100.00 A |
| | triazolamine | | | | | |
| | salt (SP) | | | | | |
| 5 | 48% | 3,000 | 16.25 F | 51.25 E | 55.00 F | 55.00 D |
| | Glyphosate | | | | | |
| 6 | 48% | 5,000 | 30.00 E | 62.50 D | 73.75 CD | 95.00 A |
| | Glyphosate | | | | | |
| 7 | 48% | 3,000 + 250 | 40.00 D | 66.25 CD | 66.25 DE | 66.25 C |
| | Glyphosate + 2,4-D | | | | | |
| 8 | 48% | 5,000 + 250 | 70.00 A | 71.25 C | 78.75 BC | 97.50 A |
| | Glyphosate + 2,4-D | | | | | |

Within each column, values followed by different capital letter differ in 1%.

Highly significant differences exist between treatments in samples from 3 days after application (F=109.74; p<0.01), from 5 days (F=42.17; p<0.01), from 7 days (F=25.75; p<0.01), and 15 (F=63.29; p<0.01).

No differences between blocks from the four sample dates after application were observed.

Factorial Analysis of Treatments per Dates

Design of the experiment: Randomized blocks

Statistical analysis: Variance analysis (ANOVA) for a randomized bock design with factorial adjustment.

Mean difference: Duncan's test.

Program used: SAS System

Factors are analyzed separately, by comparing treatments without taking into account dates (average for such treatment in the four dates), and comparing the four dates without taking in account the treatments (average of all treatments in each date).

Treatment factor

| | Average of the |
|---|---|
| Treatments | four dates |
| 1 | 55.313 G |
| 2 | 75.625 D |
| 3 | 82.813 B |
| 4 | 89.063 A |
| 5 | 44.375 H |
| 6 | 65.313 E |
| 7 | 59.688 F |
| 8 | 79.375 C |

Values followed by different letter differ in 1%.

Date factor

| | Average of the |
|---|---|
| Dates | four treatments |
| 1 | 44.8438 D |
| 2 | 72.8125 C |
| 3 | 75.9375 B |
| 4 | 82.1875 A |

Values Followed by Different Letter Differ in 1%.

There exist highly significant difference among treatments (F=250.53; p<0.01), among sampling dates (F=585.03; p<0.1).

Highly significant interaction is observed among treatments by dates (F=15.96; p<0.01), and among treatments by blocks (F=2.99; p<0.01).

Significant interaction among treatments by blocks (F=2.99; p<0.05) is observed.

Assay Plot:

| | | | | | | | | | |
|---|---|---|---|---|---|---|---|---|---|
| 4 | 7 | 9 | 5 | 1 | 3 | 8 | 2 | 6 | Block I |
| 1 | 6 | 4 | 2 | 7 | 9 | 5 | 3 | 8 | Block |
| | | | | | | | | | II |
| 4 | 2 | 8 | 6 | 9 | 3 | 7 | 1 | 5 | Block |
| | | | | | | | | | III |
| 3 | 8 | 1 | 5 | 6 | 2 | 4 | 9 | 7 | Block |
| | | | | | | | | | IV |

Although the invention is described in reference to specific modifications and embodiments, such as those related to the aforementioned examples, the provided details are not to be considered as limitations, except those specifically referred to the shown extension, as indicated in the following clauses.

1. A N-(phosphonomethyl)glycine(Glyphosate) salt wherein said salt is the N-(phosphonomethyl-glycine) 1H-1,2,4-triazole-3-ylamine salt (Glyphosate triazolamine salt).

2. The N-(phosphonomethyl)glycine(Glyphosate) salt, according to claim 1, which comprises the N-(phosphonomethyl)glycine mono 1H-1,2,3-triazole-3-ylamine salt (Glyphosate mono-triazolamine salt) of formula:

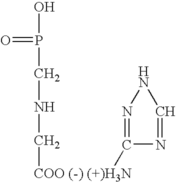

3. A concentrate useful formula for “in situ” preparation of a phytotoxic formulation by dilution in water, wherein such composition is a liquid product with active compound comprising the N-(phosphonomethyl)glycine 1H-1,2,3-triazole-3-ylamine salt (Glyphosate triazolamine salt), according to claim 1, and at least one auxiliary including agriculturally acceptable diluents, extensors, carriers, conditioning agents, humidifying agents, and/or dispersing or emulsifying agents.

4. A concentrate useful composition for “in situ” preparation of a phytotoxic formulation by dissolution in water, wherein such composition is a powdered or granulated product, which active compound comprises the N-(phosphonomethyl)glycine 1H-1,2,3-triazole-3-ylamine salt (Glyphosate triazolamine salt), according to claim 1, and optionally at least one auxiliary comprising agriculturally acceptable diluents, extensors, carriers, conditioning agents, humidifying agents, and/or dispersing or emulsifying agents.

5. The concentrate composition according to claim 3, wherein the N-(phosphonomethyl)glycine 1H-1,2,3-triazole-3-ylamine salt (Glyphosate triazolamine salt) is the N-(phosphonomethyl)glycine mono 1H-1,2,3-triazole-3-ylamine salt (Glyphosate mono-triazolamine salt).

6. The concentrate composition according to claim 3, wherein such auxiliary comprises a humidifying agent selected from sodium nonyl-phenolpolyhexilate, and lamilsulphonate.

7. The concentrate composition according to claim 3, wherein such powdered additive is selected from the group consisting of kaolinite, attapulgite, silica, an diatom-earth.

8. The concentrate composition according to claim 3, wherein such auxiliary comprises a dispersing agent selected from polyvynil-alcanol, methylcellulose, and sodium naphtalenesulphonate.

9. A phytotoxic composition comprising an active compound such as a N-(phosphonomethylglycine) 1H-1,2,4-triazol-3-ylamine salt (Glyphosate triazolamine salt), according to claim 1, together with an agriculturally acceptable auxiliary.

10. The phytotoxic formulation according to claim 9, wherein such N-(phosphonomethylglycine) 1H-1,2,4-triazol-3-ylamine salt (Glyphosate triazolamine salt) is the N-(phosphonomethylglycine)mono-1H-1,2,4-triazol-3-ylamine salt (Glyphosate mono-triazolamine salt).

11. The phytotoxic formulation according to claim 9, comprising an aqueous solution.

12. The phytotoxic formulation according to claim 9, comprising a powdered preparation.

13. A process for preparing a liquid concentrate composition of the N-(phosphonomethylglycine) 1H-1,2,4-triazol-3-ylamine salt (Glyphosate triazolamine salt), according to claim 1, comprising: (a) the suspension of acid glyphosate in water; and (b) the slowly addition of triazolamine under constant stirring, and keeping the temperature from 15 to 40° C.

14. The process according to claim 13, additionally comprising the addition of an auxiliary, including agriculturally acceptable diluents, extensors, carriers, conditioning agents, humidifying agents and/or dispersing or emulsifying agents.

15. A process for preparing a solid concentrate composition of the N-(phosphonomethylglycine) 1H-1,2,4-triazol-3-ylamine salt (Glyphosate triazolamine salt), according to claim 1, comprising the mixture of acid glyphosate and triazolamine.

16. The process according to claim 15, additionally comprising the addition of an auxiliary including agriculturally acceptable diluents, extensors, carriers, conditioning agents, humidifying agents and/or dispersing or emulsifying agents.

17. A process to prepare a ready-to-use formulation of the N-(phosphonomethylglycine) 1H-1,2,4-triazol-3-ylamine salt (Glyphosate triazolamine salt), comprising the dilution in water of the liquid concentrate composition obtained according to claim 13, to reach the required active compound concentration.

18. A process to prepare a ready-to use formulation of the N-(phosphonomethylglycine) 1H-1,2,4-triazol-3-ylamine salt (Glyphosate triazolamine salt), comprising the dilution in water of the solid concentrate composition obtained according to claim 15, to reach the required active compound concentration.

19. A method to combat weeds in a crop, comprising the application of the phytotoxic formulation according to claim 9, on the weeds existing in a crop.

20. The method according to claim 19, additionally comprising the previous stage of preparing the phytotoxic formulation from a concentrate composition of the active compound.

21. The method according to claim 19, wherein the application is preformed previously to the sowing.

22. The method according to claim 19, wherein the application is performed immediately after the sowing.

23. The method according to claim 19, wherein the application is performed after the sowing, but before the-emergency of the culture.

24. The method according to claim 19, wherein the application is performed on a plantation of fruit trees.

25. The method according to claim 19, wherein the application is performed to control the weeds selected from the group consisting in Aleppo grass (Sorghum halepense), Bermuda grass (Cynodon dactylon), water grass (Echinochloa crusgalli), summer grass (Digitaria sanguinalis), “sunchillo” (Wedelia glauca), nutgrass (Cyperus rotundus), blite (Amaranthus quitensis), wild buckwheat (Polygonum convolvulus), and pigweed (Chenopodium album).
